(19) United States
(12) Patent Application Publication
(10) Pub. No.: US 2009/0255464 A1
(43) Pub. Date: Oct. 15, 2009

(54) DEVICE FOR APPLYING ACTIVE SUBSTANCES TO SURFACES OF MEDICAL IMPLANTS, PARTICULARLY STENTS

(76) Inventors: Gerd EISOLD, Grosselfingen (DE); Klaus EPPLE, Rangendingen (DE); Lars SUNNANVAEDER, Hechingen (DE); Boris BEHNISCH, Tubingen (DE)

Correspondence Address: MORRISON & FOERSTER LLP, 12531 HIGH BLUFF DRIVE, SUITE 100, SAN DIEGO, CA, 92130-2040, US

(21) Appl. No.: 12/419,971

(22) Filed: Apr. 7, 2009

Related U.S. Application Data
(63) Continuation of application No. PCT/EP2007/008587, filed on Oct. 4, 2007.

(30) Foreign Application Priority Data
Oct. 12, 2006 (DE) 10 2006 050 221.3

(51) Int. Cl. B05C 5/00

(52) U.S. Cl. 118/320; 118/300

(57) ABSTRACT

A device for applying active substances to surfaces of medical implants (11) has a base station (22) and a replaceable cartridge (10) that can be mounted on the base station, the cartridge (10) having a holder for the implants (11) and also a nozzle for spraying the active substance onto the surface. The base station (22) has a drive unit (75) for moving the holder and the nozzle in relation to each other. For this purpose, the cartridge (10) has a basically cylindrical first housing part (14) which has the holder and a basically cylindrical second housing part (15) which has the nozzle. The first and second housing parts (14, 15) are formed so that they fit into each other and are arranged so that they can be moved, and preferably rotated, relative to each other (FIG. 8).

### RELATED APPLICATIONS

This is a continuation application of International Patent Application PCT/EP2007/008587, filed Oct. 4, 2007, designating the United States and published in English as WO 2008/043467, which claims priority of German patent application DE 10 2006 050 221.3, filed Oct. 12, 2006. The entire contents of these prior applications are incorporated herein by reference.

### BACKGROUND OF THE INVENTION

1. Field of the Invention

The present invention relates to a device for applying active substances to surfaces of medical implants, with a base station and a replaceable cartridge that can be mounted on the base station, the cartridge having a holder for the implants and also a nozzle for spraying the active substance onto the surface, and the base station having a drive unit for moving the holder and the nozzle in relation to each other.

2. Related Prior Art

A device of this kind is known from WO 2004/091684 A1.

The known device, and also other devices—known from U.S. Pat. No. 6,395,326 and DE 202 00 223 U1, are intended for coating stents, i.e. vascular prostheses, with drugs. These coatings are desirable because they can improve the biocompatibility of the implants, thereby preventing, for example, the development of thromboses at surfaces that come into contact with blood.

As regards stents in particular it is also known that their surfaces may be coated with drugs, such as rapamycin, in order to prevent re-stenosis due to proliferation of the surrounding tissue. Suitably coated stents can in addition be used for targeted delivery of drugs, on the spot as it were, into the surrounding tissue.

The prior art contains many descriptions of stents that can be coated with different active substances; see, for example, DE 202 00 220 U1, EP 0 875 218 A2, or EP 0 950 386 A2. These stents are generally placed in the body and released at the place where they are to be used with the aid of so-called introducer systems, being loaded, for this purpose, on catheters which are advanced through the relevant blood vessels by means of guide wires that run through the internal lumen of the catheter, according to the so-called Seldinger technique.

Other medical implants, too, often require a suitable surface coating as they need to be biotolerable, something which their surfaces themselves do not provide. In the present application an implant is understood to mean not only prostheses that remain in the patient's body permanently but also other devices that remain in the body for a long time, such as indwelling catheters, which are used for intravenous feeding, etc. in the most seriously ill, paralysed, or unconscious patients.

In the known devices the active substance is sprayed via a nozzle onto the outer surface of the stent, where it is deposited and dries off. This requires a relative movement between the nozzle and the stent along the longitudinal axis of the stent and, in addition, either relative rotation between the stent and the nozzle or the use of a ring nozzle which is moved along the implant and thereby ensures that the active substance sprayed on is distributed around its circumference.

It has been found that in many ways the devices known from U.S. Pat. No. 6,395,326 and DE 202 00 223 U1 do not meet modem requirements in many ways in regard to the use of implants in general and stents in particular, in particular that they do not allow the ever more frequently required or desired flexibility and individual adaptability in regard to coating. p In the device known from the type-defining WO 2004/091684 A1, these problems are obviated by means of a two-element design comprising a reusable base station and single-use cartridges which are supplied together with the stents that are to be coated ready-inserted in the cartridge. On each of the cartridges there is a longitudinally moveable sliding spray carriage which carries a ring nozzle and which, when the cartridge is inserted into the base station, engages with the latter's drive unit which then moves the sliding spray carriage.

The sliding spray carriage has a plug-type connector for a syringe that holds the active substance, the plug-type connector being in fluid connection with the ring nozzle, whilst the base station has a stop for the plunger of the syringe, such that movement of the sliding spray carriage not only distributes the active substance over the stent but at the same time conveys the active substance from the syringe to the nozzle. Upstream of the ring nozzle, on the sliding spray carriage, there is a drying nozzle by means of which a drying medium supplied from outside, usually sterile air, is directed onto the stent section already coated in order to dry the coat.

On the front side of the cartridge there is a holder for the implants; on the sliding spray carriage there is a further holder for a protective cover that surrounds the implants. As the sliding spray carriage moves, this further holder is thus moved longitudinally relative to the implant, such that the protective cover is automatically removed from the implant during the spraying process.

An unlocking arrangement is provided for each of the two holders; the unlocking arrangement automatically releases the implant when the sliding spray carriage is moved beyond the basic position that it occupies when the implant to be coated is initially inserted, to the first front side. In this way the implant is released automatically, which means that the cartridge no longer has to be opened when coating is over; when coating is completed, the implant can be removed immediately.

In sum, the cartridge thus contains only one moving part, i.e. the sliding spray carriage, allowing the contents of a syringe to be applied to the surface of the implant, and the resulting coating to be dried, in a single linear movement. This process can be repeated, if necessary, with a syringe containing a new drug. A further movement of the sliding spray carriage then releases the stent, allowing it to be removed from the cartridge.

With the known device it is thus possible to carry out sterile coating in the catheter laboratory itself. The cartridge is used once only, allowing the base station to be used to coat large numbers of implants one after the other without major cleaning interventions, without the risk of cross-contamination.

However, the known device, too, still has disadvantages in some respects, firstly because the coating process takes a relatively long time and the homogeneity of the coating is not always optimal and secondly because temporary storage of coated implants is not possible.

### SUMMARY OF THE INVENTION

In view of the above, the object of the present invention is to further develop the known device in such a way that these disadvantages are avoided.

According to the invention, this and other objects are achieved by means of a device of the kind mentioned at the outset, in which the cartridge comprises an essentially cylindrical first housing part which has the holder and an essentially cylindrical second housing part which has the nozzle, the first and second housing parts being formed so that they fit into each other, being arranged so that they can be moved, and preferably rotated, relative to each other, and also preferably having a tight sterile seal between them.

The object underlying the invention is achieved completely in this way.

This is because the inventors of the present application have recognized that this abandonment of the principle of the sliding spray carriage which is arranged so that it can be moved within the cartridge not only makes it possible to achieve qualitatively better coating but also improves the sterile seal. The two housing parts that can be moved into each other act as a kind of air pump; air only reaches the inside via openings provided for this specific purpose; these openings can be connected to the environment via sterilizing filters arranged on the cartridge, allowing the cartridge as a whole to be sealed off, sterile, with respect to the outside.

Now, too, the drive for the relative movement between the two housing parts no longer needs to engage with the inside of the cartridge; cut-throughs in the outer of the two housing parts are no longer necessary because both housing parts are accessible from the outside, with the result that the drive can act there. This, too, allows a better sterile seal.

This sterile seal is also maintained after coating is over, allowing a coated implant to remain in the cartridge and be stored sterile with it. For the first time, therefore, it is possible to coat implants individually on the spot and to prepare coated implants in advance to a certain extent.

Furthermore, when the housing parts can also be rotated in relation to each other, it is not absolutely necessary to distribute the active substance around the circumference of the implant with a ring nozzle. According to the inventors' discovery, the rotation of the nozzle connected to the second housing part which is effected by the rotation of the second housing part makes it possible to distribute the coat uniformly around the circumference more effectively and more rapidly.

The new device thus has all the advantages of the device known from WO 2004/091684 A1, but in addition ensures more homogeneous coating and allows coated implants to be stored.

It is preferable, a manner known per se, if the implant is a stent loaded on a catheter.

The stent can then be implanted immediately after coating and any further temporary storage; further manipulation of the stent is not necessary because it is already together with its introducer system.

According to a further object the cartridge is sealed off, sterile, with respect to the environment by means of seals and filters.

The advantage of this measure is that coated implants can be stored for longer, as contaminants are thereby more effectively prevented from getting inside the cartridge. Because of the “air pump principle” already mentioned above and the sterile seal between the first and the second housing part, penetration of air into the stationary cartridge is already inhibited anyway; sterility with respect to the environment is further improved, however, by the seals and filters at the additional openings that are needed. It is not absolutely essential for every filter to be a sterilizing filter; one-way valves or non-return valves or standard filters can also be used when it is a matter of filtering air coming from inside the “air pump”. The objective here is basically to ensure that no drug residues find their way into environmental air.

The advantage of using valves rather than membrane filters is that the pressure inside the cartridge can be higher, i.e. the implant can be sprayed at a higher pressure than is the case when merely membrane filters are used.

It should be mentioned, in this connection, that all the materials employed must be resistant to the spray medium, which is usually a solvent, and to the drugs, which are sometimes aggressive or toxic, in order to ensure that the inside of the cartridge remains sealed off even under prolonged storage.

According to another object the second housing part has a plug-type connector, that is in fluid connection with the nozzle, for a replaceable syringe, the syringe serving as a reservoir for the active substance, and the plug-type connector preferably having a filter arrangement which allows active substance to enter the inside of the cartridge but filter-sterilizes incoming air.

The advantage of this is that the syringe provides an external reservoir, as it were, for the active substance. It is thus possible to use the cartridge loaded with an implant, e.g. a stent, for coating the implant with different kinds of active substances and different quantities of active substances, namely by filling an appropriate syringe with the requisite quantity of an appropriate active substance shortly before coating and then inserting the syringe into the plug-type connector.

This plug-type connector has a filter arrangement that allows only filter-sterilized air to enter the inside of the cartridge prior to the insertion of the syringe. When the syringe is inserted into the plug-type connector, the sterile closure with respect to the outside is provided by the syringe itself. The filter arrangement can then also serve to filter-sterilize the active substance required for atomization. Hydrophilic polymer membranes, for example, may be used as materials for these filters; for sterilization of compressed air, on the other hand, hydrophobic polymer membranes are used.

It is for example possible here for the plug-type connector to have a two-layer filter arrangement in which the filter for the sterilization of compressed air is on the outward side of the filter for the sterilization of drugs such that, when the syringe is inserted, this outer filter can for example be punctured or moved aside so that it does not impede the supply of the active substance to the inside of the cartridge.

It is also an object that the second housing part has a guide channel for the syringe.

The advantage of this is that the syringe is borne securely in the second housing part, and is thus not attached to the outside of the cartridge as in the known device mentioned at the start. This means, however, that it is now possible to temporarily store the cartridge with the syringe still inserted in it after an implant has been coated; there is no risk of the syringe being pulled out of the plug-type connector as a result of careless or incorrect handling. This allows even safer temporary storage of a coated implant in the cartridge.

Generally speaking, it is preferable if the base station has a stop for a plunger of the syringe.

The advantage of this is that when the second housing part is moved towards the first housing part, taking the syringe with it of course, the plunger is pressed into the syringe, simultaneously conveying active substance into the inside of the cartridge, and to the nozzle, in the process in the manner that is basically already known from the device mentioned at the outset.

According to a still further object the plug-type connector and the nozzle are in fluid connection with an air channel through which a jet of sterile air can be directed onto the implant, the air channel preferably having a section which runs roughly transverse to the syringe and which leads roughly vertically up to the implant and, at its open inner end, forms the nozzle, the air channel also preferably being sealed off, sterile, with respect to the outside by means of a sterilizing filter located in the second housing part.

The advantage of this measure is that drug entering the plug-type connector from the syringe is atomized in a technically very simple but effective way, such that a spray jet that is directed onto the surface of the implant is formed. Since the second housing part can be moved around the implant and along the length of the implant, the nozzle can thus, through movement of the second housing part, direct the spray jet onto any area of the surface of the implant, the strength of the spray jet being determined by sterile air introduced, i.e. being independent of the movement of the second housing part itself. This, too, ensures good homogeneity of the coating applied.

The sterile filter ensures that the compressed air blown in really is sterile, and that contaminants are prevented from getting inside the cartridge during storage prior to coating or during temporary storage after coating.

Generally speaking, it is preferable in such circumstances if the first housing part has a filter arrangement for exiting air from inside the cartridge, the filter arrangement sealing off the cartridge with respect to the outside and comprising an exiting-air filter and/or a valve.

This measure has the already mentioned advantage that air exiting the cartridge is also filtered even though filter-sterilization is not absolutely necessary here. It is essentially a matter of preventing drug residues from escaping from the cartridge into environmental air. It is not absolutely necessary to employ a sterile filter for this purpose; standard membrane filters can also be used; here, as at other sites, penetration of outside air into the inside of the cartridge can be prevented by the use of one-way valves or non-return valves that permit air to pass through in an outward direction only.

Moreover, it is an object that the drive unit has a shaft which acts on the second housing part in such a way that the latter can be rotated and moved longitudinally with respect to the first housing part by a movement of the shaft, the shaft preferably having a hook part which engages in the second housing part in such a way that it remains stable under rotating movement and under pressure and tension, and the hook part preferably having a section which on rotation of the shaft engages with a syringe inserted in the guide channel in such a way that the syringe locks with the plug-type connector when the shaft moves towards the cartridge.

The advantage of these measures is that a very simple drive unit which can act on the second housing part from outside without any problems is used. As already mentioned, this contributes to the sealing-off of the inside of the cartridge with respect to the outside, as the drive unit has only to act on one of the two housing parts from outside to rotate it and move it longitudinally. The shaft provided on the base station is a technically simple realization of this drive principle, in which, by means of the hook part, the shaft may also be locked onto the second housing part in an extremely simple manner by a mere twisting or inserting action.

According to the invention this hook part has yet a further function, however; in a certain angular orientation of the shaft with respect to the cartridge it also serves to push a syringe that has been inserted in the guide channel further into the cartridge so that it locks securely with the plug-type connector. This is a safety measure. This series of movements of the shaft prior to the start of coating can be automated, ensuring that the syringe is always locked in position before the coating process begins.

According to another object, running through the shaft, there is an air-supply channel by means of which air can be directed into the air channel.

The advantage of this measure is that the shaft not only drives the second housing part but also, at the same time, supplies compressed air to the inside of the cartridge, where this compressed air is used to atomize the active substance. This measure is thus advantageous from a constructional viewpoint in particular because the base station only needs to act on the cartridge via this shaft; the shaft both supplies the requisite sterile compressed air and ensures that the syringe is properly locked, and, finally, also moves and rotates the second housing part.

In this constructionally very simple way it is possible to ensure very homogeneous coating, as one series of movements which ensures all the necessary measures is all that is required.

Furthermore, it is an object that the first housing part has a first gripping element as a holder for the implants; on the second housing part there is preferably a second gripping element to hold a protective cover that surrounds the implants; furthermore, for the first and/or second gripping element there is preferably an unlocking device on the second and/or first housing part.

The advantage of this measure is that the implants are held in the cartridge in such a way that, through the relative movement between the first and the second housing parts, the protective cover is at the same time removed from the implant or, after coating, i.e. when the second housing part is pushed back into the first housing part, moved back over the implant again. The implant in the cartridge thus once again has the additional protection of the protective cover, this protective cover being particularly effective on subsequent removal of the implant from the cartridge.

The unlocking device that is in each case provided on the other housing part ensures, a manner known per se, that, when the first and second housing parts are pushed fully together for example, both gripping elements are released, allowing the implant to then be removed from the cartridge in a longitudinal direction towards the rear aspect. It is not necessary to open the cartridge in such circumstances, one advantage of this being that drug residues present in the cartridge cannot escape. Another advantage is that the cartridge does not have to allow the option of subsequent opening, which thus means that the design of the cartridge has only to ensure the sterile seal with respect to the outside.

It is preferable in such circumstances if the first gripping element is formed to hold a catheter that carries a stent and the second gripping element is formed to hold a protective cover that sits over the stent, preferably on a stylet which is connected to the protective cover and which projects into a guide channel in the catheter.

The advantage of this is that it is possible to use standard stents loaded on a catheter with a stylet running through the internal lumen of the catheter; internally, the cartridge is thus arranged to hold standard stents.

Generally speaking, it is also preferable in such circumstances if the base station has a sensor, preferably a proximity switch, which indicates when the stop is in contact with the plunger.

The advantage of this measure is that the coating process, thus the introduction of compressed air into the inside of the cartridge, does not commence until the base station has ascertained, by means of the sensor, that the second housing part has been drawn so far out of the first housing part that the syringe is in contact with the stop. This is because the stent-loaded cartridge is supplied with the second housing part virtually fully inserted into the first housing part, in which state the nozzle is situated a little way upstream of the stent. After the shaft has engaged with the second housing part, the latter is first drawn out of the first housing part until the plunger is in contact with the stop. The design is such that even then the nozzle is still situated slightly upstream of the implant, with the result that certain fluctuations in the length of the plunger of the syringe, etc. do not have any effect on the quality of the coating.

A particular advantage of this measure is that the sensor serves to determine both whether the cartridge has been correctly inserted in the base station and whether the shaft has gripped the second housing part securely. Further sensors can thus be dispensed with, which is a constructional advantage.

The invention also relates to a cartridge for the new device. This cartridge is designed as a disposable item and has the features already described in connection with the new device.

The invention also relates to a base station for the new device. This base station is re-usable and has the features already described in connection with the new device.

A kit comprising a new cartridge and at least one syringe is also the subject of the present invention. Together with the cartridge, the syringe, whereby the active substance is delivered, is supplied in the kit. The syringe, too, may be designed as a disposable item. This gives the doctor the appropriate syringe as well as the cartridge.

Finally, this invention also relates to a sterile-packed cartridge according to the invention with an implant within it, the implant preferably being a stent loaded on a catheter.

The advantage of this is that the implants are supplied sterile-packed, already loaded in the cartridge, which means that they can be held in stock in the catheter laboratory. The doctor has then only to select a cartridge containing the desired implant, insert it in the base station, charge a syringe with the appropriate active substance, and push it into the cartridge; right up until the end of the coating process, no handling steps involving the implant itself are required. The original sterility, as ensured during the manufacture of the implant and its “mounting” in the cartridge in the same clean-room, is thus preserved.

After the coating, the cartridge can be taken out of the base station and stored again, sterile. Since the cartridge has not had to be opened and remains sealed off, sterile, with respect to the outside, there is no risk of the coated implant becoming contaminated.

For the first time it is thus possible, to a certain extent, to hold uncoated and coated implants in stock for a certain time with adequate sterility. It is for example possible to coat the implants that are required for the following few days once a week only and store them until the operation in question, which not only saves time and money. This is because the coating can be carried out “in peace” as it were, i.e. without the time pressure and the stress that are present during an ongoing operation, bringing further quality advantages.

With the new device, however, it is also possible, at any time, to quickly coat an appropriate implant with the requisite active substance during an ongoing operation or shortly before, particularly when it emerges, in connection with an operation that may already be ongoing, that an implant and/or active substance different from the one(s) originally planned is (are) required.

Other advantages and features are presented in the following description and in the enclosed figures.

It goes without saying that the features mentioned above and those still to be explained below can be used not only in the stated combination but also in other combinations or on their own without going beyond the scope of the present invention.

### BRIEF DESCRIPTION OF THE DRAWINGS

Illustrative embodiments of the invention are explained in greater detail, with reference to the figures, in the description below.

FIG. 1 shows a schematic, perspective view of the new cartridge;

FIG. 2 shows a perspective top view of the new base station with the new cartridge inserted in it and with the plunger of the syringe not yet in contact with the stop;

FIG. 3 shows a view as in FIG. 2, but with the second housing part now drawn so far out of the first housing part that the plunger is in contact with the stop;

FIG. 4 shows an enlarged perspective view of the second housing part in the state presented in FIG. 2;

FIG. 5 shows a view as in FIG. 4, but in the state presented in FIG. 3;

FIG. 6 shows a schematic longitudinal section through the new cartridge in a state corresponding to FIG. 5;

FIG. 7 shows an enlarged view of the cartridge area in FIG. 6 in which the coating of the implant takes place; and

FIG. 8 shows a schematic lateral view of a cartridge inserted in the base station, in a state corresponding to FIG. 5.

### DETAILED DESCRIPTION OF A PREFERRED EMBODIMENT

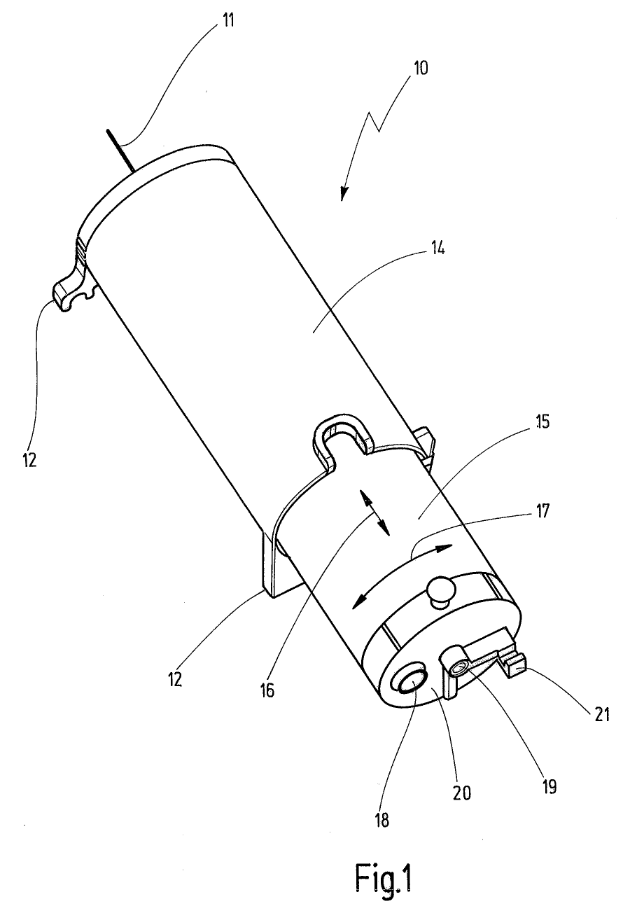

10 in FIG. 1 refers to a cartridge which has inserted within in it an implant 11, indicated only schematically, which is to be coated with an active substance in a manner yet to be described. For this purpose, the implant is inserted in a base station by means of feet 12 and locked there accordingly.

The cartridge 10 has a first cylindrical housing part 14 in which there is a second, likewise cylindrical, housing part 15 which can be moved longitudinally in the direction of an arrow 16, and rotated in the direction of an arrow 17, in the first housing part 14.

In this way the first and second housing parts 14, 15 act as a kind of air pump; when the second housing part 15 is pushed into the first housing part 14, air inside the cartridge 10 is forced out.

The second housing part 15 has a guide channel, indicated by 18, for a syringe which contains the active substance used for coating the implant 11. The second housing part 15 also has an air channel 19 via which compressed air, preferably sterile compressed air, is conveyed into the inside of the cartridge 10, where it is used to atomize the active substance contained in the syringe. The air channel 19 is located in the centre of a front wall 20 of the second housing part 15; it also serves, in a manner yet to be described, to bring about the movement of the second housing part 15 in relation to the first housing part 14, the front wall 20 being additionally provided with a trap 21.

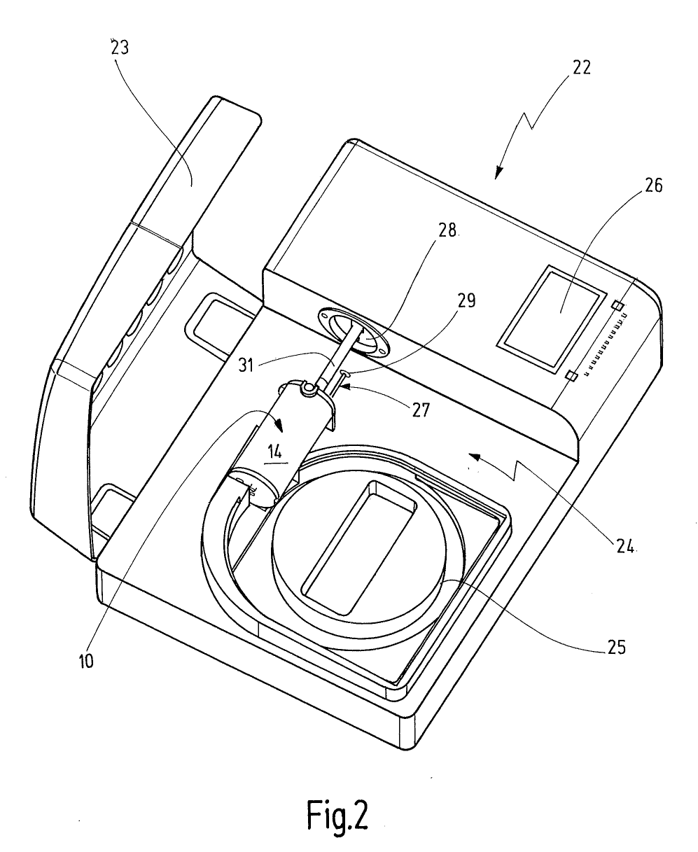

FIG. 2 shows a schematic view of a base station 22 which has a hinged cover 23 whereby a compartment 24 holding the cartridge 10 can be covered after the cartridge 10 has been inserted. Also shown in the compartment 24 is a transport winder 25 which holds the implant 11 section that projects beyond the cartridge 10, i.e. a catheter with the associated introducer system.

In FIG. 2 it can seen that on the right there is also an operating and monitoring unit 26 whereby the coating of the implants is controlled and the coating process can be checked.

In FIG. 2 the cartridge 10 is locked in the compartment 24; a syringe 27 for the active substance has already been inserted in the guide channel 18 that can be seen in FIG. 1; a plunger 29 of the syringe 27 can be seen.

For this plunger 29 the base station has a stop 28 with which the plunger 29 comes into contact when the second housing part 15 is drawn out of the first housing part 14.

For this purpose the base station 22 has a shaft 31 which, in FIG. 2, has already engaged with the second housing part.

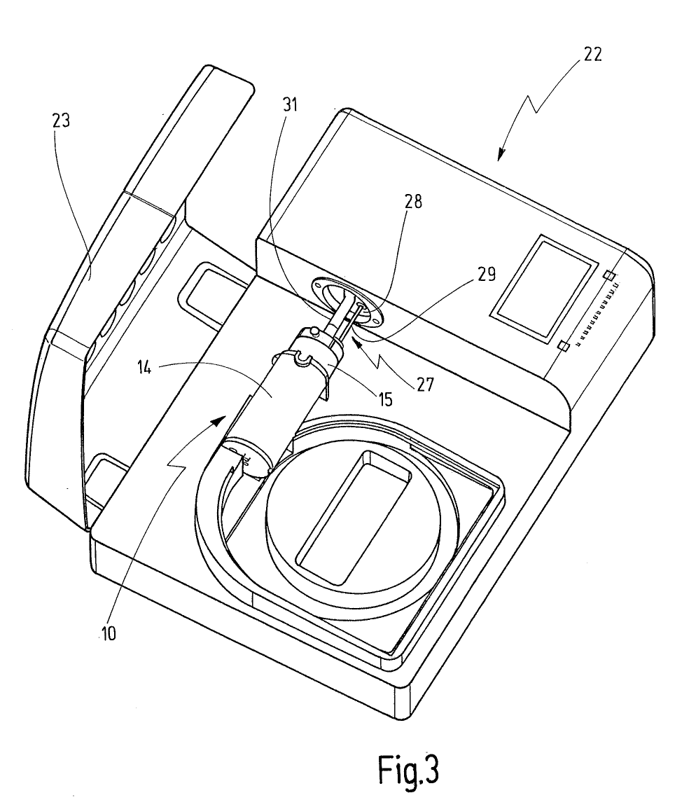

When the shaft 31 is withdrawn into the base station 22, as shown in FIG. 3, the second housing part 15 is drawn out of the first housing part 14, bringing the plunger 29 into contact with the stop 28.

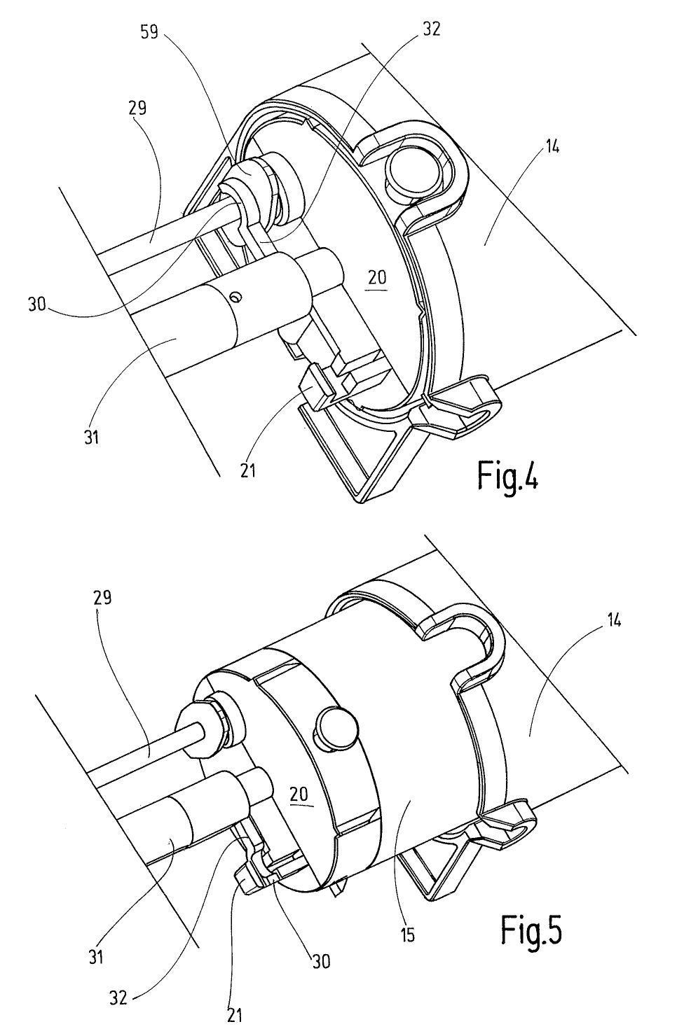

FIGS. 4 and 5, each of which presents a perspective detail in the region of the front wall 20, show how the shaft 31 engages with the second housing part 15.

FIG. 4 shows the process state of FIG. 2; the shaft 31 has advanced so far that it has engaged in the air channel 19 (FIG. 1). At its front end the shaft 31 has a hook part 32, which, in FIG. 4, has been turned so far counterclockwise that its part 30 is resting on the plunger 29 and, on further advancement of the shaft 31, has pressed the syringe 27 into the guide channel 18 so that it locks properly. In FIG. 4, only the barrel head 59 of the syringe 27 is visible; the barrel head is mentioned further below.

In the switch from FIG. 4 to FIG. 5, which shows the process state of FIG. 3, the shaft 31 has first been turned 180° clockwise such that the hook part 32 is now engaged in the trap 21. Then, on the drawing-back of the shaft 31, the second housing part 15 has been drawn out of the first housing part 14 such that the plunger 29 is in contact with the stop 28.

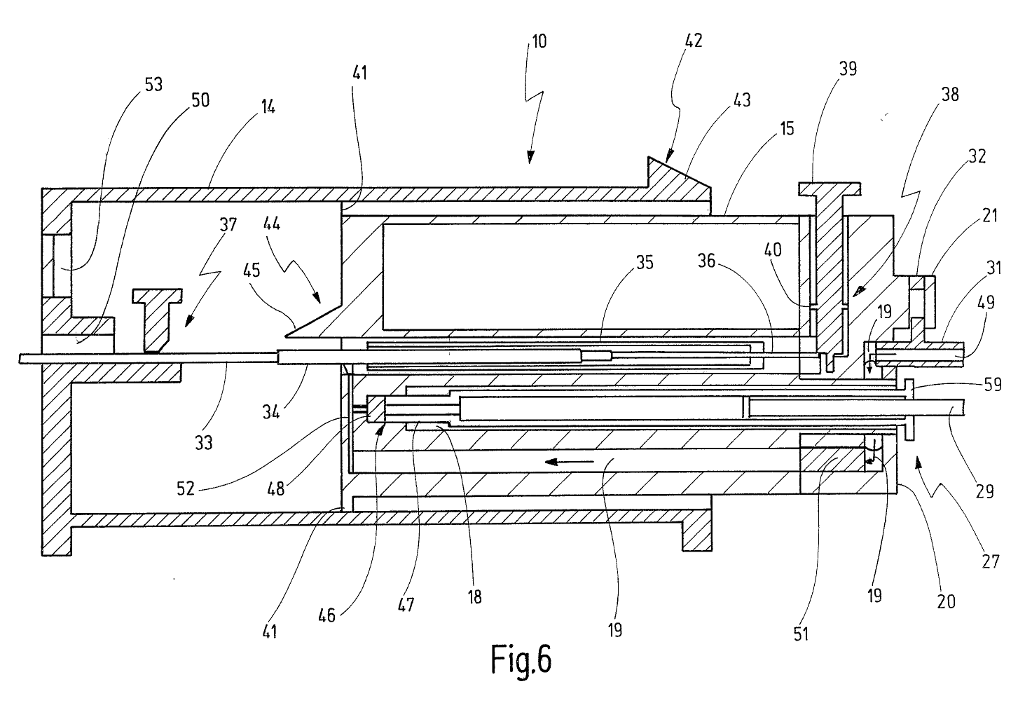

This state is shown in FIG. 6, which shows a schematic longitudinal section through the new cartridge 10.

The implant to be coated is a stent 34 which is loaded on a catheter 33 and which is surrounded by a protective cover 35 that is connected to a stylet 36 inserted into the internal lumen of the catheter 33. During the implantation of the stent the usual guide wire runs through this internal lumen, which cannot be seen in the figures; during transportation and coating the internal lumen contains the stylet 36.

The catheter 33 is held firmly in the first housing part 14 by means of a gripping element 37 which is shown only schematically in FIG. 6, whilst the stylet 36 is firmly connected to the second housing part 15 by a second gripping element 38 which is likewise shown schematically. This second gripping element 38 has an outwardly projecting stylet bar 39 which lies in the second housing part 15, within which it can be moved longitudinally and is sealed off, sterile, with respect to the outside by means of a sealing lip 40.

In FIG. 6 it can also be seen that between the first housing part 14 and the second housing part 15 there is a sealing ring 41 which forms a tight, sterile seal between the inside of the cartridge 10 and the outside.

The first housing part 14 also has an unlocking device 42 in the form of a ramp 43 which, when the second housing part 15 is pushed fully into the first housing part 14, pushes the stylet bar 39 outwards, releasing the stylet 36.

In the same way, the second housing part 15 has an unlocking device 44 in the form of a ramp 45 which, when the second housing part 15 is pushed fully into the first housing part 14, opens the first gripping element 37, releasing the catheter 33.

The arrangement of the first and second gripping elements 37, 38 and of the two unlocking devices 42 and 44 is such that the second housing part 15 can be pushed into the first housing part 14 almost completely without releasing the gripping elements 37, 38. The gripping elements 37, 38 are only released, and the coated stent 34 can only be removed from the cartridge 10, when the second housing part 15 is pushed fully into the first housing part 14.

In FIG. 6 it is also possible to see the guide channel 18 which runs longitudinally through the second housing part 15 and which accommodates the syringe 27 or its plunger. At the internal end of the guide channel 18 there is a plug-type connector 46 for a tip 47 of the syringe 27, the plug-type connector additionally having a filter arrangement 48.

In the second housing part 15, running parallel to the guide channel 18, is the air channel 19, which is bent in the area of the front wall 20, where it changes into an air-supply channel 49 provided in the shaft 31 that has been inserted into the air channel 19. In FIG. 6 it can also be seen that the hook part 32 is engaged in the trap 21, allowing the shaft 31, on movement and rotation, to move the second housing part 15 accordingly relative to the first housing part 14.

In the air channel 19 there is a sterilizing filter 51 which ensures that air supplied through the air-supply channel 49 is filter-sterilized again before it reaches the coated stent 34. This takes place via an air channel 19 section 52 which leads roughly vertically to the stent 34 and which runs transverse to the tip 47 of the syringe 27.

In FIG. 6 it can also be seen that the first housing part 14 also has a sterile feed-through 50 for the catheter 33 and in addition a filter arrangement 53 for exiting air from inside the cartridge 10.

The inside of the cartridge 10 is sealed off, sterile, with respect to the outside by means of the seals and filters 40, 41, 48, 50, 51 and 53; when the second housing part 15 is drawn out of the first housing part 14, air reaching the inside of the cartridge 10 (air pump principle) is filter-sterilized; air exiting the cartridge 10 is filtered at least to the extent that no contaminants can escape from the inside of the cartridge 10. This exiting air arises whenever compressed air has reached the inside of the cartridge 10 via the air-supply channel 49 and the air channel 19, or the second housing part 15 is pushed into the first housing part 14. Because of the seals 40, 41, 50, air can only escape through the filter arrangement 53, which, instead of a membrane filter or in addition to a membrane filter, may also contain a one-way valve or a non-return valve.

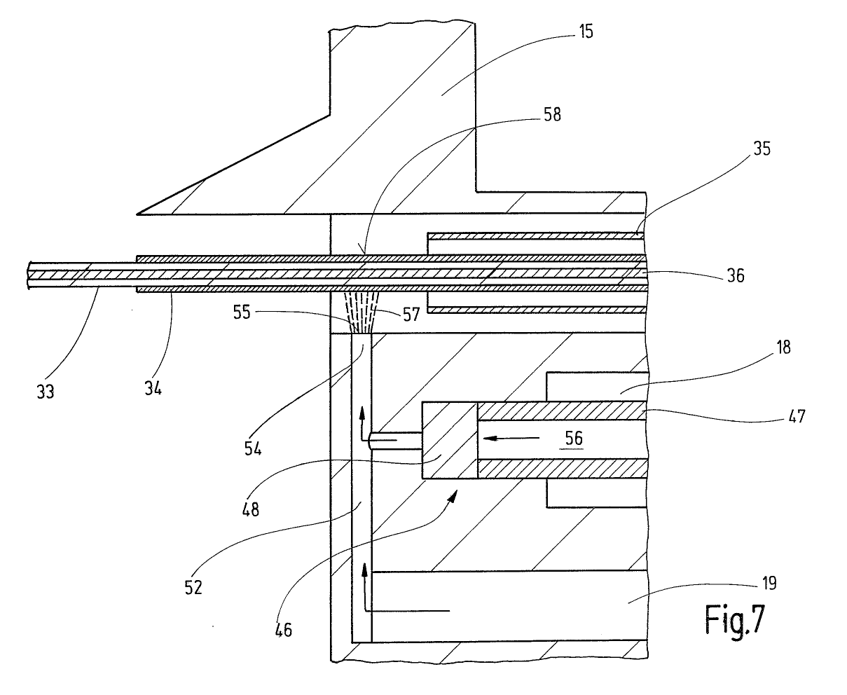

The way in which the stent 34 is coated will now be described with the aid of FIG. 7, which is an enlarged view of the inner section of the second housing part 15 in the area of the plug-type connector 46.

In FIG. 7 it can be seen, first of all, that at its open inner end 54 the section 52 which runs transverse to the air channel 19 changes into a nozzle 55 from which active substance 56 contained in the syringe 27 is atomized in a spray jet 57. For this purpose, compressed air passes via the air channel 19 into the section 52, into which active substance 56, too, is pressed as the plunger 29 travels into the syringe 27 (FIG. 6). The compressed air carries this active substance 56 along with it and atomizes it, in the nozzle 55, to form the spray jet 57, which accordingly coats the surface 58 of the stent 34 with the active substance 56. Since the housing part 15 can be moved both longitudinally along, and around the circumference of, the stent 34, the spray jet 57 can reach every area of the surface 58 and thus ensure uniform, homogeneous coating.

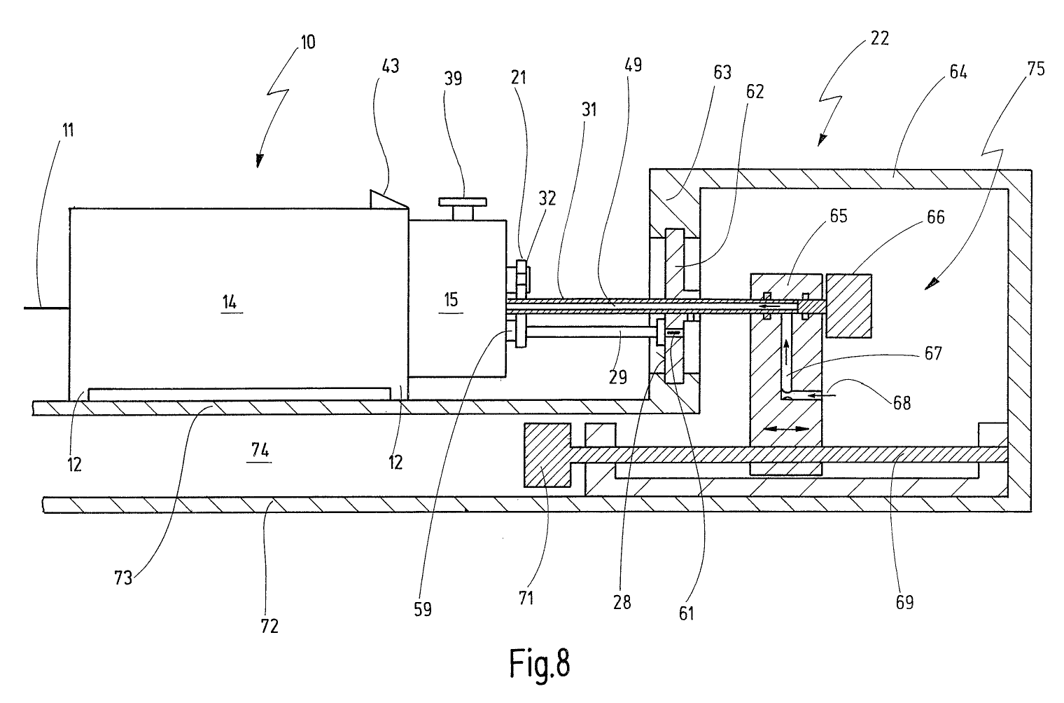

The way in which this movement of the second housing part 15 relative to the first housing part 14 takes place will now be described with the aid of FIG. 8, which shows a schematic lateral view of FIGS. 3 and 5. FIG. 8 essentially shows the base station 22 in a schematic lateral sectional view; the cartridge 10 itself is only indicated in outline.

The only visible part of the syringe 27 is a barrel head 59, on which the plunger 29, which is already in contact with the stop 28, projects. It can also be seen that the hook 32 is engaged in the trap 21.

On the base station 22, in the area of the stop 28, there is a sensor 61 in the form of a proximity switch arranged in a rotation wheel 62 which is rotatably arranged in a front wall 63 of a casing of the base station 22.

The shaft 31, which passes through the centre of this rotation wheel 62, is rotatably mounted on a sliding carriage 65 inside the base station 22 and is there driven, i.e. rotated, by a motor 66. When the shaft 31 turns, it drives the second housing part 15, and the rotation wheel 62 with which the plunger 29 is in contact is turned with it at the same time.

The sliding carriage 65 has an air duct 67 by means of which the preferably sterile compressed air indicated by an arrow 68 can pass into the air-supply channel 49 in the shaft 31.

The sliding carriage 65 is carried on a shaft 69 which is driven by a motor 71, such that the sliding carriage 65 in FIG. 8 can be moved to the left or to the right through leftward or rightward rotation of the motor 71.

The assembly described so far is arranged in a base station 22 space 74 between a base plate 72 and a plate 72 and forms a drive unit 75.

By means of the drive unit 75, after a new cartridge has been inserted in the base station 22 the shaft 31 is first turned by the motor 66 until the hook part 32 hooks over the plunger 29. The sliding carriage 65 is then moved to the left, with the result that the shaft 31 enters the air channel 19 that can be seen in FIG. 1; in the process, the hook part 32 comes into contact with the barrel head 59 of the syringe 27 and pushes the syringe 27 into the second housing part 15, or into the guide channel 18, until it locks securely in position inside.

Next, the shaft 31 is turned clockwise by the motor 66 so that the hook part 32 engages with the trap 21. The sliding carriage 65 is then moved to the right until the sensor 61 indicates that the plunger 29 is in contact with the stop 28.

Compressed air 68 is then passed into the air-supply channel 49 through the air duct 67 whilst the second housing part 15 is moved longitudinally, and rotated, with respect to the first housing part 14 by the two motors 66 and 71, thereby coating the implant homogeneously and completely about its circumference.

As soon as the coating process has been completed, the compressed air 68 is switched off and the sliding carriage 65 in FIG. 8 is moved to the left until the second housing part 15 has been more or less completely pushed into the first housing part 14. The cartridge 10 with the coated stent 34 can be temporarily stored in this state. Then, when the stent 34 is to be removed from the cartridge 10, the second housing part 15 is pushed completely into the first housing part 14, releasing the corresponding gripping elements 37, 38. In FIG. 8, in this connection, it can be seen only that the ramp 43 then pulls the stylet bar 39 outwards.

In sum, with the new device described so far it is thus possible to coat an implant with an active substance homogeneously and uniformly, and for the coated implant to remain and be temporarily stored in the cartridge even if the latter has already been removed from the base station 22.

The base station 22 can then be re-used; with it, different implants can be coated one after the other with different active substances; no contamination of the base station 22 itself occurs.

The implants are supplied sterile-packed, loaded in a cartridge 10; it is only in the catheter laboratory that the syringe 27 is charged with the relevant active substance 56 and inserted in the guide channel 18 before the cartridge 10 is then inserted in the base station 22.

1. Device for applying at least one active substance to surfaces of medical implants, comprising
a replaceable cartridge with a holder for said implants and a nozzle for spraying said active substance onto the surface,
said holder comprising a basically cylindrical first housing part which has arranged thereon the holder and comprising a basically cylindrical second housing part which has arranged thereon the nozzle,
said first and second housing parts being formed such that they fit into each other and being arranged such that they are movable, and preferably rotatable, relative to each other, and
a base station, on which the cartridge is to be mounted,
the base station having a drive unit for moving the holder and the nozzle in relation to each other.

2. The Device of claim 1, wherein the first and second housing parts have a tight, sterile seal arranged between them.

3. The Device of claim 1, wherein the cartridge is sealed off, sterile, with respect to the environment by means of seals and filters.

4. The Device of claim 1, wherein the medical implant is a stent loaded on a catheter.

5. The Device of claim 1, wherein the second housing part comprises a plug-type connector for a replaceable syringe, the plug-type connector being in fluid connection with the nozzle, the syringe serving as reservoir for the active substance.

6. The Device of claim 5, wherein the plug-type connector comprises a filter arrangement which allows active substance to enter the inside of the cartridge but filter-sterilizes incoming air.

7. The Device of claim 5, wherein the second housing part comprises a guide channel for the syringe.

8. The Device of claim 5, wherein the base station comprises a stop for a plunger of the syringe.

9. The Device of claim 5, wherein the plug-type connector and the nozzle are in fluid connection with an air channel through which a jet of sterile air is to be directed onto the implant.

10. The Device of claim 9, wherein the air channel comprises a section which runs roughly transverse to the syringe, this section leading roughly vertically up to the implant when mounted and, at its open inner end, forming the nozzle.

11. The Device of claim 9, wherein the air channel is sealed off, sterile, with respect to the outside by means of a sterilizing filter located in the second housing part.

12. The Device of claim 1, wherein the first housing part has a filter arrangement for exiting air from inside the cartridge, the filter arrangement sealing off the cartridge with respect to the outside and comprising an exiting-air filter and/or a valve.

13. The Device of claim 1, wherein the drive unit comprises a shaft which acts on the second housing part in such a way that the latter is rotated and moved longitudinally with respect to the first housing part by a movement of the shaft.

14. The Device of claim 13, wherein the shaft has a hook part which engages in the second housing part in such a way that it remains stable under rotating movement and under pressure and tension.

15. The Device of claim 14, wherein the hook part has a section which on rotation of the shaft engages with a syringe inserted in the guide channel in such a way that the syringe locks with the plug-type connector when the shaft moves towards the cartridge.

16. The Device of claim 13, wherein the shaft has running through it an air-supply channel by means of which air is to be directed into the air channel.

17. The Device of claim 1, wherein in the first housing part there is a first gripping element serving as said holder for said implants.

18. The Device of claim 1, wherein in the second housing part there is arranged a second gripping element to hold a protective cover that surrounds the implants.

19. The Device of claim 17, wherein an unlocking device for the first gripping element is provided on the second and/or first housing part.

20. The Device of claim 18, wherein an unlocking device for the second gripping element is provided on the second and/or first housing part.

21. The Device of claim 17, wherein the first gripping element is formed to hold a catheter that carries a stent.

22. The Device of claim 18, wherein the second gripping element is formed to hold a protective cover that covers the stent.

23. The Device of claim 22, wherein the protective cover sits on a stylet which is connected to the protective cover and which projects into a guide channel in the catheter.

24. The Device of claim 8, wherein the base station has a sensor, preferably a proximity switch, which indicates when the stop is in contact with the plunger.

25. Cartridge to be used as the replaceable cartridge in the device of claim 1, comprising
a holder for medical implants and a nozzle for spraying at least one active substance onto the surfaces of medical implants,
said holder comprising a basically cylindrical first housing part which has arranged thereon the holder and comprising a basically cylindrical second housing part which has arranged thereon the nozzle,
said first and second housing parts being formed such that they fit into each other and being arranged such that they are movable, and preferably rotatable, relative to each other.

26. Cartridge of claim 25, which it is sterile-packed with an implant arranged therein, the implant preferably being a stent loaded on a catheter.

27. Base station for mounting thereon the cartridge of claim 25.

28. Base station of claim 27, having a drive unit for moving said holder for medical implants and said nozzle for spraying said at least one active substance in relation to each other.

29. Kit comprising the cartridge of claim 26 and at least one syringe.

30. Replaceable Cartridge for being mounted on a base station to form a device for applying at least one active substance to surfaces of medical implants, said cartridge comprising
a holder for said implants,
said holder comprising a basically cylindrical first housing part which has arranged thereon the holder, and
a basically cylindrical second housing part
said basically cylindrical second housing part having arranged thereon a nozzle for spraying said active substance onto the surface,
said first and second housing parts being formed such that they fit into each other and being arranged such that they can be moved, and preferably rotated, relative to each other.

31. The Replaceable Cartridge of claim 30, wherein the first and second housing parts have a tight, sterile seal arranged between them.

32. The Replaceable Cartridge of claim 30, wherein the second housing part comprises a plug-type connector for a replaceable syringe, the plug-type connector being in fluid connection with the nozzle, and the syringe serving as reservoir for the active substance.
